(19) United States
(12) Patent Application Publication
(10) Pub. No.: US 2007/0288360 A1
(43) Pub. Date: Dec. 13, 2007

(54) Systems and methods for determining whether candidates are qualified for desired situations based on credit scores

(76) Inventor: Joseph Guy Seeklus, Vancouver (CA)

Correspondence Address: SCHACHT LAW OFFICE, INC., SUITE 202, 2801 MERIDIAN STREET, BELLINGHAM, WA, 98225-2412, US

(21) Appl. No.: 11/784,239

(22) Filed: Apr. 5, 2007

Related U.S. Application Data
(60) Provisional application No. 60/797,769, filed on May 3, 2006.

(51) Int. Cl. G06Q 40/00

(52) U.S. Cl. 705/38

(57) ABSTRACT

An interface system for matching an applicant with a position based on credit information. The interface system comprises a credit user entry module, an applicant entry module, a credit bureau module, a decision module, and a notification module. The credit user entry module allows a credit user to define the position and enter a position grade associated with the position. The applicant entry module allows the applicant to enter applicant information. The credit bureau module generates an applicant grade based on the applicant information and credit information stored in a credit bureau database. The decision module compares the position grade with the applicant grade to determine whether the applicant is qualified for the position. The notification module notifies the credit user and the applicant whether the applicant is qualified for the position.

### RELATED APPLICATIONS

This application claims benefit of U.S. Provisional Application Ser. No. 60/797,769 filed on May 3, 2006, which is incorporated herein by reference.

### FIELD OF THE INVENTION

The present invention relates to systems and methods for determining individual qualifications based on the individual's credit history and, more specifically, to systems and methods that facilitate the process of determining, based on credit histories, whether a candidate is qualified for a desired position or situation.

### BACKGROUND OF THE INVENTION

A credit score is a number generated based on an individual's credit history that indicates the likelihood that that individual will repay a loan. In the United States, credit scores are compiled by three major credit bureaus: Experion, Equifax, and TransUnion. Credit bureaus generate credit scores based on comprehensive credit histories. Credit reports, which typically contain the credit score and a summary of the information used to establish the credit score, can be obtained from the credit bureaus.

Traditionally, credit histories, often in the form of credit scores, have been used by lending institutions to determine whether to make loans to individuals or business and the terms of such loans. In recent years, credit histories and credit scores have been adopted for other, non-traditional, uses. For example, credit scores are used by insurance companies to determine insurance rates, by employers to evaluate job applicants, and by landlords to evaluate prospective tenants. In these cases, the individual whose credit history has been checked will be referred to herein as the applicant.

Credit scores and credit reports have thus become fundamental to the core businesses of institutions such as banks and insurance companies; such institutions have thus developed sophisticated systems for incorporating credit scores and/or credit reports into internal decision making processes.

However, infrequent credit report users, such as employers who wish to evaluate job applicants and landlords who wish to evaluate prospective tenants, are often companies or individuals who do not use credit scores and credit reports as part of their core businesses. Infrequent credit score users thus typically do not have the benefit of institutionalized systems for accessing and evaluating credit scores and credit reports.

Credit reports contain, and credit scores represent, highly sensitive credit history information that can easily be misused. Accordingly, access to credit scores and credit reports is highly regulated. While it is possible for infrequent credit score users to procure credit scores and credit reports directly from the credit bureaus, the relatively complex legal regulations related to the distribution of credit reports render such procurement impractical. Accordingly, infrequent credit score users typically employ third party facilitators to simplify the distribution and interpretation of credit scores and credit reports.

From the perspective of the infrequent credit score users, then, third party facilitators simplify the process of obtaining and interpreting credit scores and credit reports. The credit bureaus are motivated to use third party facilitators because third party facilitators serve the needs of groups of infrequent credit score users that are too small for the credit bureaus to justify serving directly.

Credit bureaus currently require that the credit score user obtain a signed consent form from the applicant. The signed consent form is then transmitted to a third party facilitator or the credit bureau, which then performs the credit check.

One of the factors used to determine a credit score is the number of credit checks or inquiries received. In the past, an elevated number of recent credit inquiries has been associated with an increased risk of default. A credit score traditionally has thus decreased if more than a predetermined number of credit inquiries has been received within a predetermined time period. The increased use of credit scores and credit reports by non-traditional users of credit scores has thus resulted in a class of credit inquiries that are not necessarily related to increased risk of default.

The credit industry has thus established at least the following two distinct classes of credit inquiries: “hard” inquiries and “soft” inquires. Hard inquiries are inquiries that are associated with an increased risk of default and conventionally lower credit scores in many circumstances. Soft inquiries are inquiries that are not necessarily associated with an increased risk of default and do not adversely affect credit scores. An example of a soft inquiry is an inquiry initiated by the individual to check on his own credit history. In addition, the Applicant is currently establishing procedures that will enable a potential tenant to be pre-approved for one or more properties, residential or commercial, using a similar soft inquiry.

The present invention is of particular significance in the context of making soft inquiries for the purpose of supplying credit scores and credit reports to infrequent credit score users such as potential landlords and employers, and the present invention will be described herein in that context. The present invention may, however, have broader application to other types of credit inquiries and other types of credit score users.

In this context, the need exists for improved systems and methods for supplying credit information to users of credit information.

### SUMMARY OF THE INVENTION

The present invention may be embodied as an interface system for matching an applicant with a position based on credit information. The interface system comprises a credit user entry module, an applicant entry module, a credit bureau module, a decision module, and a notification module. The credit user entry module allows a credit user to define the position and enter a position grade associated with the position. The applicant entry module allows the applicant to enter applicant information. The credit bureau module generates an applicant grade based on the applicant information and credit information stored in a credit bureau database. The decision module compares the position grade with the applicant grade to determine whether the applicant is qualified for the position. The notification module notifies the credit user and the applicant whether the applicant is qualified for the position.

### DESCRIPTION OF THE DRAWINGS

FIG. 1 is a block diagram of a first example matching system of the present invention;

FIG. 2 is a flow chart representing a first example of a landlord entry module of the first example matching system;

FIG. 3 is a flow chart representing a first example of a tenant entry module of the first example matching system;

FIG. 4 is a flow chart representing a first example of a decision module of the first example matching system;

FIG. 5 is a flow chart representing a first example of a credit bureau module of the first matching system;

FIG. 6 is a block diagram of a second example matching system of the present invention;

FIG. 7 is a flow chart representing a second example of a landlord entry module of the second example matching system;

FIG. 8 is a flow chart representing a second example of a tenant entry module of the second example matching system;

FIG. 9 is a flow chart representing a second example of a decision module of the second example matching system;

FIG. 10 is a flow chart representing a second example of a credit bureau module of the second matching system;

FIG. 11 is a block diagram of a third example matching system of the present invention;

FIGS. 12A and 12B are flow charts representing the operation of a host listing service of the third example matching system;

FIG. 13 is a third example of a landlord entry module of the third example matching system;

FIG. 14 is a flow chart representing a third example of a tenant entry module of the third example matching system;

FIG. 15 is a block diagram of a fourth example matching system of the present invention.

### DETAILED DESCRIPTION OF EXAMPLES OF THE INVENTION

The present invention may be embodied in a number of forms, and several example embodiments will be described below.

### I. First Embodiment

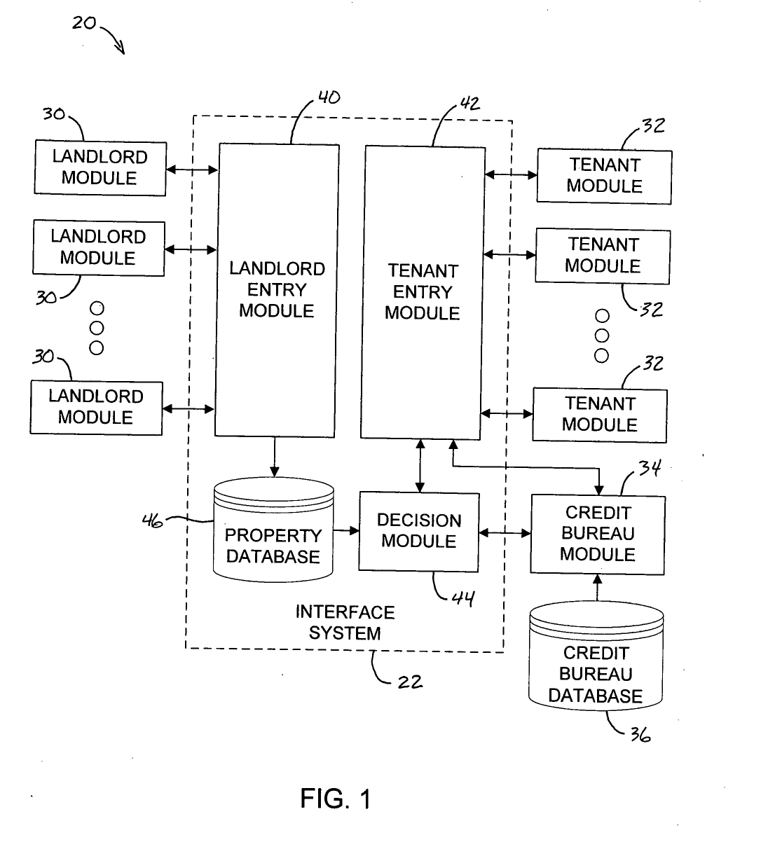

Referring initially to FIG. 1 of the drawing, depicted at 20 therein is a first example matching system constructed in accordance with, and embodying, the principles of the present invention.

The first example matching system 20 comprises an interface system 22 that coordinates communication between one or more landlord entry modules 30, one or more tenant entry modules 32, and a credit bureau module 34. The credit bureau module 34 facilitates access by the interface system 22 to a credit bureau database 36. The example interface system 22 comprises a landlord entry module 40, a tenant entry module 42, a decision module 44, and a property database 46.

The example matching system 20 operates basically as follows. The landlord entry module 40 allows prospective landlords to enter into the interface system 22 property data associated with each available property for use by the decision module 44. In the example matching system 20, the property data is stored in the property database 46. The example landlord entry module 40 further allows the prospective landlord to enter a minimum acceptable credit level for each available property.

The tenant entry module 42 allows prospective tenants to enter tenant data and property criteria data. The tenant entry module 42 stores the tenant data and the property criteria data for a period of time as will be described below. The tenant entry module 42 further sends the tenant data to the credit bureau module 34.

The credit bureau module 34 generates a tenant grade for each prospective tenant based on the tenant data received from the tenant entry module 42 and the contents of the credit bureau database 36. The credit bureau module 34 transmits the tenant grade to the tenant entry module 42. The tenant entry module 42 stores the tenant grade, again for a period of time as will be described below.

The decision module 44 generates a list of compatible properties for each prospective tenant based on the minimum credit grades entered by prospective landlords, the property criteria data entered by the prospective tenants, and the tenant grade generated by the credit bureau module 34. In particular, for each property, the decision module 44 determines whether the potential tenant meets minimum requirements defined by the credit grade and whether the property data satisfies the property criteria. The lists of compatible properties thus represent a match between qualified prospective tenants and available rental properties meeting the requirements of the prospective tenants.

The tenant entry module 42 further allows the prospective tenants to generate lists of desired properties based on the lists of compatible properties. The lists of desired properties identify which of the compatible properties are of interest to the prospective tenants.

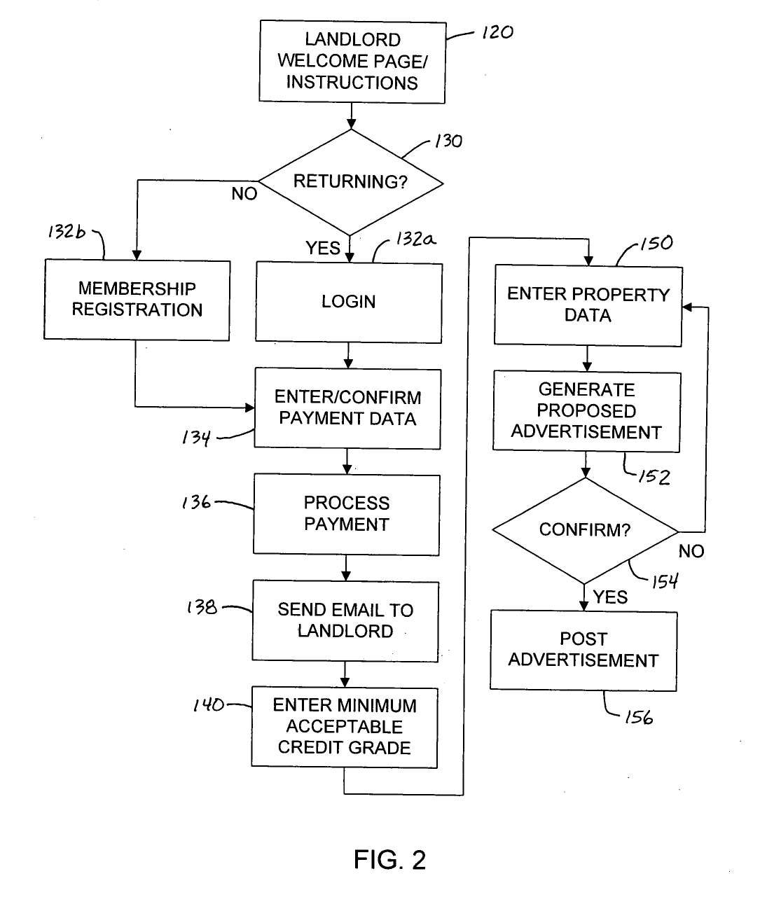

Referring now to FIG. 2 of the drawing, the operation of the example landlord entry module 40 will be described in further detail. The example landlord entry module 40 is implemented as one or more web pages configured to prompt the prospective landlord to enter, for each available property, property data, payment data, and the credit grade defining the minimum acceptable tenant requirements.

In particular, as shown in FIG. 2, the prospective landlord is initially presented with a welcome/instruction screen 120 that introduces the prospective landlord to the example matching system 20. The landlord entry module 40 next determines at step 130 whether or not the prospective landlord is a returning member. If so, the process proceeds to a login step 132a. If not, the process requests the landlord to enter membership information at step 132b.

After either of these steps 132a and 132b, the process requests that the landlord enter or confirm payment information at step 134. The payment information typically takes the form of credit card information, but other payment methods can be used as well. At step 136, the landlord entry module 40 processes payment (e.g., obtains payment from a credit card company). At step 138, the process sends a welcome email to the prospective landlord.

The landlord entry module 40 allows the landlord to enter a minimum acceptable credit grade at step 140. The minimum acceptable credit grade can take many forms, such as conventional number or letter grades (e.g., A, B, C, etc.), icon ratings (1 star, 2 star, 3 star, etc.), and binary ratings (good, better). When multiple ratings levels are used, the prospective landlord has more than two classes from which to select. If a binary rating system is used, all prospective tenants must be included in one of two classes. As will be described in further detail below, the acceptable credit grade is based on factors associated with credit worthiness and is designed to suggest whether a prospective tenant will be a good tenant.

The following Score Card table provides one example of a letter based grading system that may be used by a matching system 20 of the present invention:

Score Card

| | |
|---|---|
| A | This grade is based on a credit score of 776–850. |
| | This grade does not allow most collections, |
| | bankruptcies, or judgments.* |
| B | This grade is based on a credit score of 701–775. |
| | This grade does not allow most collections, |
| | bankruptcies, or judgments.* |
| C+ | This grade is based on a credit score of 671–700. |
| | This grade does not allow most collections, |
| | bankruptcies, or judgments.* |
| C | This grade is based on a credit score of 621–670. |
| | This grade does not allow most collections, |
| | bankruptcies, or judgments.* |
| C− | This grade is based on a credit score of 581–620. |
| | This grade can include a collection and/or a |
| | bankruptcy.* |
| D | This grade is based on a credit score of 550–580. |
| | This grade can include a collection and/or a |
| | bankruptcy.* |
| D− | This grade is based on a credit score of 500–549. |
| | This grade can include up to two collections, a |
| | bankruptcy, and/or a judgment.* |
| F | This grade is based on a credit score of 450–499. |
| | This grade can include up to three collections, up to |
| | two bankruptcies, and/or a judgment.* |

*Please Note the Following Exemptions: Medical Collections, Paid
Collections, Collections Less Than $100.00 (if and only if there are
less than ten items total in collections), and Judgments under
$500.00.

| | |
|---|---|
| Credit | A credit score is determined by an algorithm based |
| Score: | on a consumers late payments, bankruptcies, |
| | collections, judgments, current debts, how long |
| | accounts have been open and established, the type |
| | of credit (credit cards vs. finance company loan, |
| | etc.) and applications for new credit or inquires. |
| Bankruptcy: | A bankruptcy is declared when a consumer is ruled |
| | to be unable to satisfy their creditors or discharge |
| | liabilities by a court of law. |
| Judgment: | A judgment occurs when a financial obligation, such |
| | as a debt, is determined by a court of law. |
| Collections: | Any unpaid account submitted to a collection |
| | agency. |

As shown at step 150, the next step is for the prospective landlord to enter property data. In the example matching system 20, the property data includes information that a prospective tenant may find of interest when selecting a property. For example, a prospective tenant might be interested in characteristics of the rental property such as location (address, neighborhood, etc.), size (square feet, number of rooms, etc.), construction type (wood frame, brick, etc.), area schools, rent payment, and amenities (pool, gym, etc.). The property data may further include additional marketing information such as photographs, video clips, and flash presentations. The property data may also include a link to an informational website operated by the landlord.

After the property data has been entered at step 150, the system generates a proposed advertisement at step 152. The prospective landlord is given the option of confirming the completeness and accuracy of the proposed advertisement at step 154. If the proposed advertisement is incomplete or inaccurate, the process returns to step 150 and allows the prospective landlord to add to or correct the property data. If the proposed advertisement is complete and accurate, the advertisement is posted at step 156.

A typical web page defines an interface that is not necessarily sequential in operation, but rather allows the user to enter data in any order, so long as data input logic is maintained. Many of the steps described above with reference to FIG. 2 thus need not be performed in the order described herein. For example, the property data may be entered (step 150) before the step of entering the acceptable tenant grade. However, data input logic dictates that the login step should be performed prior to the entry of acceptable tenant grade or property data and that the proposed advertisement should not be generated until the property data is initially entered.

In addition, certain of the steps depicted and described with reference to FIG. 2 may be omitted. For example, the matching system 20 may be configured as a free service, in which case steps 130-138 may be omitted. The confirmation step 154 may also be skipped in certain embodiments of the present invention.

The example depicted in FIG. 2 and described herein is thus presented by way of example only, and a landlord entry module 40 of the present invention may be embodied in forms other than that described herein.

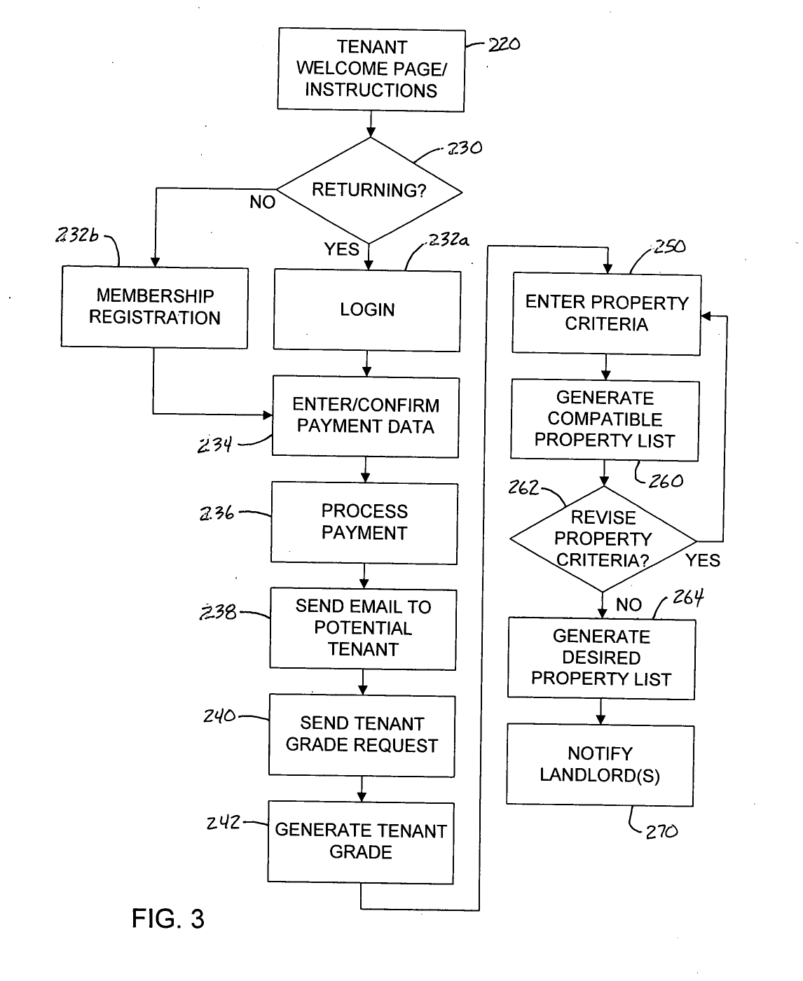

Referring now to FIG. 3 of the drawing, the operation of the example tenant entry module 42 will be described in further detail. The example tenant entry module 42 is also implemented as one or more web pages configured to prompt the prospective landlord to enter tenant data, payment data, and property criteria.

In particular, as shown in FIG. 3, the prospective tenant is initially presented with a welcome/instruction screen 220 that introduces the prospective tenant to the example matching system 20. The tenant entry module 42 next determines at step 230 whether or not the prospective tenant is a returning member. If so, the process proceeds to a login step 232a. If not, the process requests the tenant to enter membership information at step 232b.

After either of these steps 232a and 232b, the process requests that the tenant enter or confirm payment information at step 234. The payment information typically takes the form of credit card information, but other payment methods can be used as well. At step 236, the tenant entry module 42 processes payment (e.g., obtains payment from a credit card company). At step 238, the process sends a welcome email to the prospective tenant.

With the permission of the prospective tenant, the tenant entry module 42 next sends, at step 240, a tenant grade request to the credit bureau module 34. The tenant grade request contains enough of the tenant information to allow the credit bureau module 34 to generate the tenant grade at step 242.

The tenant entry module 42 next allows the prospective tenant to enter property criteria at step 250. In the example matching system 20, the property criteria are typically defined by the property data associated with the available properties. In particular, the property criteria allow the potential tenant to select a property having only certain characteristics, such as a particular location, meeting a certain size range, being of a particular construction type, being within certain school service areas, being within a predetermined range of rents, and having predetermined amenities.

At step 260, the tenant entry module 42 directs the decision module 44 to generate a list of compatible properties. The tenant entry module 42 presents this list of compatible properties to the prospective tenant for review. The prospective tenant may elect at step 262 to return to step 250 to revise the property criteria. In this case, step 260 is repeated and a new list of compatible properties is generated.

At step 264, the tenant entry module 42 allows the prospective tenant to generate a listed of desired properties by selecting one or more of the available properties contained in the list of compatible properties. The available properties contained in the list of desired properties represent properties for which the prospective tenant has been pre-approved and in which the prospective tenant has an interest.

At step 270, the tenant entry module 42 sends notification to the landlord or landlords associated with the properties in the list of desired properties. The notification contains the contact information for the prospective tenant. The landlord may contact the prospective tenant for a showing of the property and/or possible lease or rental negotiations.

As described above, a typical web page defines an interface that allows the user to enter data in any order, so long as data input logic is maintained. Many of the steps described above with reference to FIG. 3 may also be performed in an order different from the order described herein. For example, the prospective tenant may be charged a fee for each available property in the list of desired properties. In this case, the processing of the payment may be deferred until after the list of desired properties has been generated at step 264. The tenant grade may also be received before or after the property criteria is entered, but the tenant grade must be entered before the list of compatible properties is generated.

In addition, certain of the steps depicted and described with reference to FIG. 3 may be omitted. For example, the matching system 20 may be configured as a free service for tenants, in which case steps 230-238 may be omitted. The steps of revising the property criteria (step 262) and generating a desired property list from the list of compatible properties (step 264) may also be skipped in certain embodiments of the present invention.

The example depicted in FIG. 3 and described herein is thus presented by way of example only, and a tenant entry module 42 of the present invention may be embodied in forms other than that described herein.

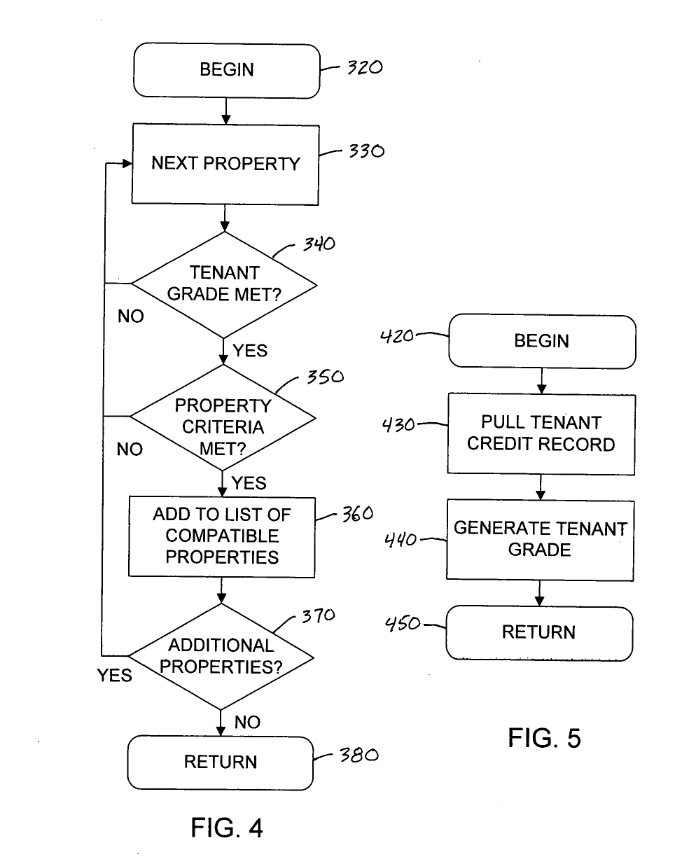

Referring now to FIG. 4 of the drawing, the operation of the example decision module 44 will be described in further detail. The example decision module 44 is implemented as a data processing algorithm configured to select certain of the available properties contained in the property database 46.

In particular, as shown in FIG. 4, the decision module 44 begins at step 320 when instructed by step 260 of the tenant entry module 42. At step 330, one of the available properties in the database 46 is identified for initial processing. The credit grade associated with the desired property is compared with the tenant grade of the prospective tenant at step 340. If the tenant grade meets the requirements defined by the credit grade, the process proceeds to step 350. If the tenant grade does not meet the requirements defined by the credit grade, the process returns to step 330, at which point another property is identified.

At step 350, the process determines whether the identified available property meets the property criteria defined by the prospective tenant. If not, the process returns to step 330, at which point another property is identified. If the identified available property meets the property requirements at step 350, the process proceeds to step 360. At step 360, the identified available property is added to a list of compatible properties.

At step 370, the process determines whether all available properties have been identified at step 330; if not, the system returns to step 330, and the next property is identified. If all available properties have been identified at step 330, the list of compatible properties is finalized, and the process ends at step 380 and returns to the tenant entry module 42. The list of compatible properties generated at step 360 is then made available to the tenant entry module 42 and displayed to the prospective tenant as described above.

Referring now to FIG. 5 of the drawing, the operation of the example credit bureau module 34 will be described in further detail. The example decision module 44 is implemented as a data processing algorithm configured to generate a tenant grade based on a prospective tenant's credit records.

When the tenant entry module 42 sends the credit grade request at step 240, the credit bureau module 34 begins at step 420. The tenant's credit record is pulled at step 430. Based on the tenant's credit record, the credit bureau module generates the tenant grade at step 440. At step 450, the process ends and returns to the tenant entry module 42.

The credit bureau module 34 of the example matching system 20 is configured to generate the tenant grade as a summary of the credit record that is compatible with the credit grade entered by the prospective landlords using the landlord entry module 40. Prospective landlords using the landlord entry module 40 thus are not required to know how to read a credit record.

To the contrary, in the example matching system 20, the landlords are isolated from both the credit record and from the exact tenant grade. For that matter, the matching system 20 prevents the landlord from even knowing that a prospective tenant exists if the tenant grade associated with that tenant does not meet the minimum requirements of the credit grade associated with the landlord's property or properties. Similarly, the prospective tenants are not aware that they have not qualified for a particular available property or that that property even exists.

The example credit bureau module 34 is configured to treat the credit grade request received from the tenant entry module 42 as a “soft” inquiry. A soft inquiry is preferable because it has no effect on the potential tenant's credit report. However, the credit bureau module 34 of the present invention may be configured to make a “hard” inquiry.

The exact details of the step 440 of the credit bureau module 34 depend on the details of the particular credit bureau database 36. A particular credit bureau database 36 typically contains integer and binary data values representative of an individual's credit worthiness. These values are conventionally combined as a credit score, and the tenant grade may be generated directly based on the credit score. However, a more refined approach may be to assign less or more weight to certain of the values contained in the credit record based on factors indicative of whether or not an individual is likely to be a good tenant. An individual's tenant grade may not be directly related to the individual's credit score.

As examples, the credit bureau module 34 may be configured to generate the tenant grade based on factors such as credit score, date and number of bankruptcies, date and number of items in collection, and the like.

A matching system of the present invention may be configured to include additional features. For example, as described above, the tenant entry module 42 stores the tenant data, property data, and tenant grade for a period of time. This data may be stored for only as long as necessary to generate a list of desired properties as described with reference to step 264 in FIG. 3.

However, the tenant data, property data, and tenant grade may be stored for a longer period of time (e.g. 2 weeks, 1 month). In this case, the matching system 20 can be configured to use the decision module 44 to compare, continuously or periodically, the stored tenant data, property data, and tenant grade against all new available properties entered during the period of time during which the data is stored. If the decision module 44 determines at a later time that a match exists, the matching system 20 notifies the prospective tenant, for example by email, that a new matching available property has been entered.

Also, while the example matching system 20 is configured to accommodate multiple available properties and multiple potential tenants, the system 20 may be configured to allow a potential tenant to apply for one specific property. In this case, if the tenant grade meets the requirements defined by the credit grade, the matching system would notify the landlord that owns that particular property that a potential match exists.

Along similar lines, a landlord who is aware of a potential tenant can email a link to that person directing the potential tenant to apply online through the matching system 20. In this case, the matching system 20 may be configured to handle multiple listed properties from multiple landlords, but the email sent from the landlord can contain the property criteria that will allow the potential to apply specifically to that landlord's property.

The matching system 20 can be configured to keep records of situations in which potential tenants have entered property criteria that match available properties but were turned down based on credit. The system can be configured to notify the landlord of this situation. Depending upon market considerations, the landlord may elect to change the minimum acceptable credit grade such that certain potential tenants may quality.

As another option, the matching system can be provided with a landlord grading system that allows tenants to rate their existing landlords. Future prospective tenants can review such ratings when making the decision whether to rent from a particular landlord.

Another option would be to allow prospective tenants to attempt to improve their tenant grade. For example, a prospective tenant may be too young to obtain a good tenant grade. In this case, the prospective tenant may not want to rent any of the available properties for which they are qualified. The matching system may be configured to increase the prospective tenant's tenant score if the prospective tenant takes action such as offering to pay a larger security deposit or to have another party with better credit co-sign the lease.

As described above, the example matching system 20 is implemented as a web site accessible over a communications system such as the Internet. However, data can be transmitted among the interface system 22 and the various modules 30, 32, and 34 using other technologies such as local area network, private network, telephone, facsimile, or the like. If the interface system 22 is implemented as a web page as described above, the landlord entry modules 30 and tenant entry modules 32 will typically comprise a standard web browser capable of communicating with a web page using the internet.

### II. Second Embodiment

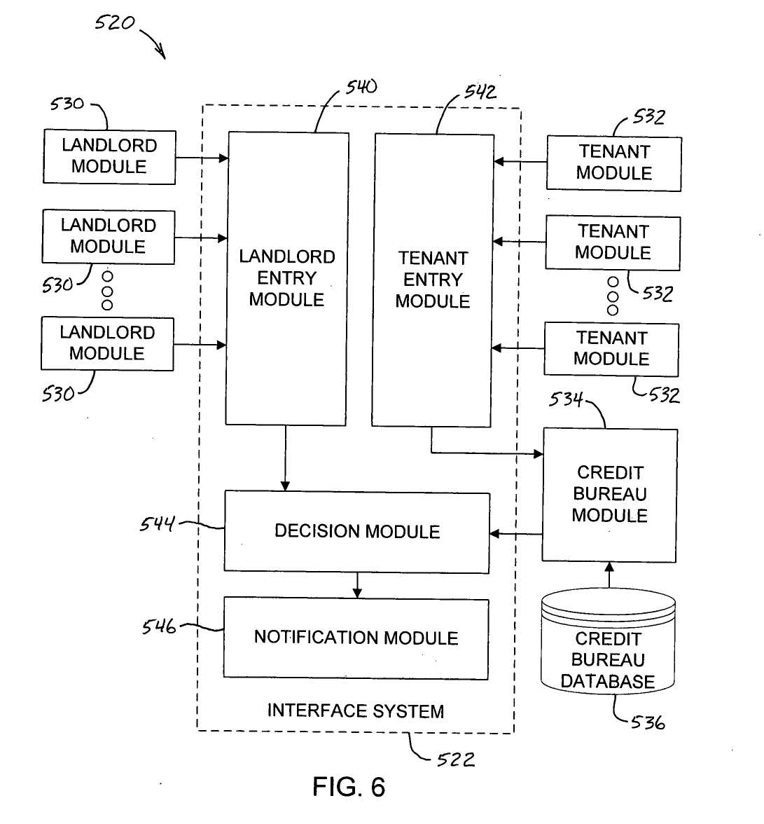

Referring now to FIG. 6 of the drawing, depicted at 520 therein is a second example matching system constructed in accordance with, and embodying, the principles of the present invention. The second example matching system 520 illustrates the principles of the present invention in the context of particular landlords who have already established contact with a prospective tenant for the purpose of possibly renting a predetermined property.

The second example matching system 520 comprises an interface system 522 that coordinates communication between one or more landlord entry modules 530, one or more tenant entry modules 532, and a credit bureau module 534. The credit bureau module 534 facilitates access by the interface system 522 to a credit bureau database 536. The example interface system 522 comprises a landlord entry module 540, a tenant entry module 542, a decision module 544, and a notification module 546.

The example matching system 520 operates basically as follows. The landlord entry module 540 allows a particular landlord to enter into the interface system 522 property data associated with the predetermined property and tenant contact data associated with a prospective tenant. The property data contains a minimum acceptable credit level chosen by the particular landlord for the predetermined property and is stored in a transaction record by the decision module 544. In the example matching system 520, the tenant contact data is transferred to the notification module 546, which sends an information request message, typically using email, to the prospective tenant.

The tenant entry module 542 allows the prospective tenant to enter tenant information in response to the information request message. The tenant entry module 542 passes the tenant information to the credit bureau module 534 and may be configured to store the tenant data for a period of time.

The credit bureau module 534 generates a tenant grade for the prospective tenant based on the tenant information received from the tenant entry module 542 and the contents of the credit bureau database 536. The credit bureau module 534 transmits the tenant grade to the decision module 544. The decision module 544 may be configured to store the tenant grade for a period of time.

The decision module 544 receives the tenant grade and compares the tenant grade with the minimum acceptable credit level associated with the particular property. The decision module 544 instructs the notification module 546 to generate an “accepted” message if the tenant grade is equal to or greater than the minimum acceptable credit level associated with the particular property and a “declined” message if the tenant grade is equal to or greater than the minimum acceptable credit level associated with the particular property. The “accepted” or “declined” messages are sent to the particular landlord and the prospective tenant. The “accepted” or “declined” messages may be sent by email, but any conventional messaging system may be used to transmit these messages.

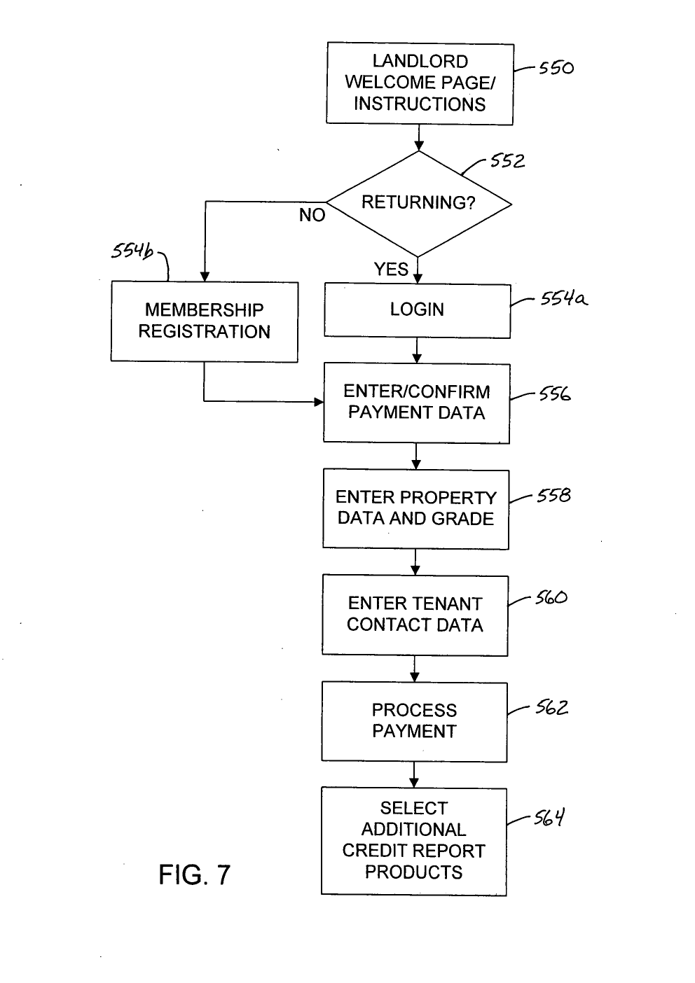

Referring now to FIG. 7 of the drawing, the operation of the example landlord entry module 540 will be described in further detail. The example landlord entry module 540 is implemented as one or more web pages configured to prompt the prospective landlord to enter, for each available property, property data, payment data, and the credit grade defining the minimum acceptable credit level requirements.

In particular, as shown in FIG. 7, the prospective landlord is initially presented with a welcome/instruction screen 550 that introduces the prospective landlord to the example matching system 520. The landlord entry module 540 next determines at step 552 whether or not the prospective landlord is a returning member. If so, the process proceeds to a login step 554a. If not, the process requests the landlord to enter at least a minimum of amount of information at step 554b.

After either of these steps 554a and 554b, the process requests that the landlord enter or confirm payment information at step 556. The payment information typically takes the form of credit card information, but other payment methods can be used as well. At step 558, the landlord entry module 540 prompts the landlord to enter a description of the property and a minimum acceptable property grade. As described above, the minimum acceptable credit grade can take many forms, such as conventional number or letter grades (e.g., A, B, C, etc.), icon ratings (1 star, 2 star, 3 star, etc.), and binary ratings (good, better).

As shown at step 560, the next step is for the prospective landlord to enter tenant contact data associated with a prospective tenant. After the tenant contact data has been entered at step 560, the landlord entry module 540 processes payment at step 562. At step 564, the landlord entry module 540 presents the landlord with the option to purchase additional credit report products. Examples of additional credit report products include identity checks and fraud alerts. Additional credit report products may include searching public and non public records, including criminal record checks, liens, judgments, sex offender registries, bankruptcies, and the like.

A typical web page defines an interface that is not necessarily sequential in operation, but rather allows the user to enter data in any order, so long as data input logic is maintained. Many of the steps described above with reference to FIG. 7 thus need not be performed in the order described herein.

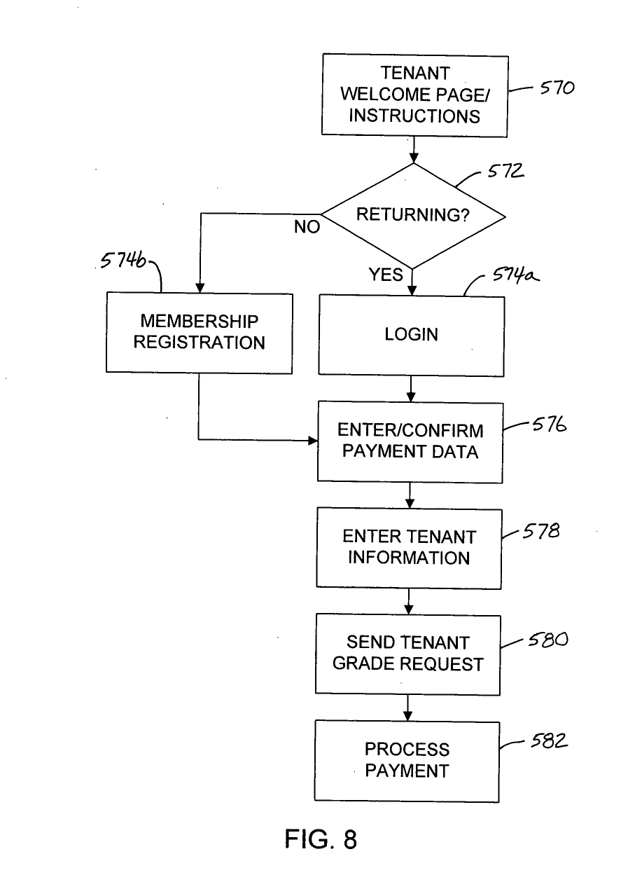

Referring now to FIG. 8 of the drawing, the operation of the example tenant entry module 542 will be described in further detail. The example tenant entry module 542 is also implemented as one or more web pages configured to prompt the prospective tenant to enter tenant data based on which a credit check may be formed.

In particular, as shown in FIG. 8, the prospective tenant is initially presented with a welcome/instruction screen 570 that introduces the prospective tenant to the example matching system 520. The tenant entry module 542 next determines at step 572 whether or not the prospective tenant is a returning member. If so, the process proceeds to a login step 574a. If not, the process requests the tenant to enter membership information at step 574b.

After either of these steps 574a and 574b, the process requests that the tenant enter or confirm payment information at step 576. The payment information typically takes the form of credit card information, but other payment methods can be used as well. At step 578, the tenant entry module prompts the prospective tenant to enter any information and authorization required to complete a credit check.

With the permission of the prospective tenant, the tenant entry module 542 next sends, at step 580, a tenant grade request to the credit bureau module 534. The tenant grade request contains enough of the tenant information to allow the credit bureau module 534 to generate the tenant grade. At step 582, the tenant entry module 542 processes payment (e.g., obtains payment from a credit card company).

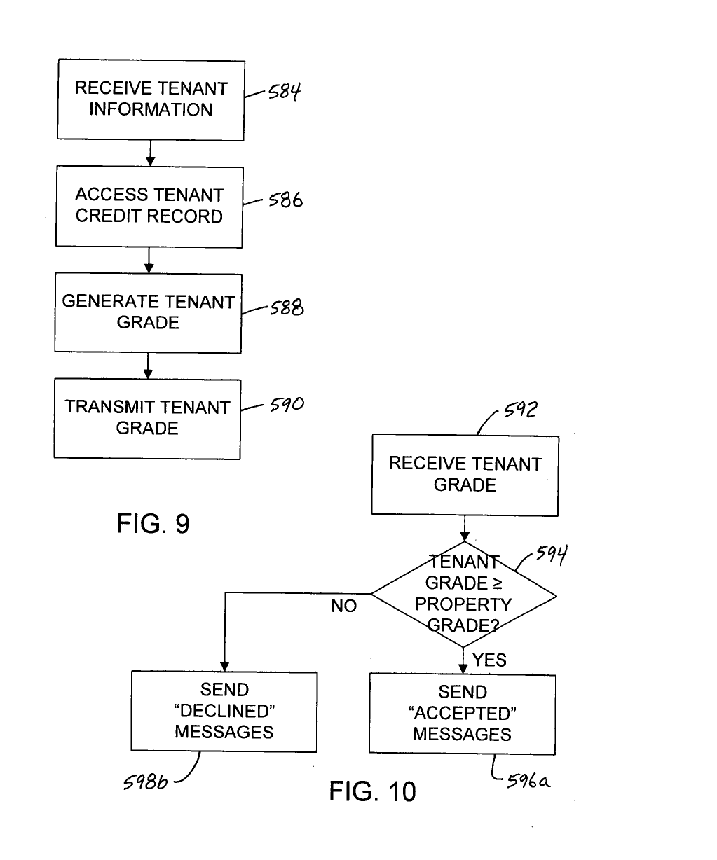

Turning now to FIG. 9, the credit bureau module 534 receives the tenant information at step 584 in response to the tenant grade request. The credit bureau module 534 then accesses the tenant credit record at step 586, generates the tenant grade at step 588, and forwards the tenant grade to the decision module 544 at step 590.

FIG. 10 shows that the decision module 544 receives the tenant grade at step 592 and determines at step 594 whether tenant grade generated by the credit bureau module 534 matches the property grade for the particular property in question. If yes, the decision module 544 instructs the notification module 546 to send an “ACCEPTED” message to both the landlord and the tenant at step 596a. If no, the decision module 544 instructs the notification module 546 to send a “DECLINED” message to both the landlord and the tenant at step 598b.

As described above, a typical web page defines an interface that allows the user to enter data in any order, so long as data input logic is maintained. Many of the steps described above with reference to FIGS. 7-10 thus may be performed in an order different from the order described herein. In addition, certain of the steps depicted and described with reference to FIGS. 7-10 may be omitted. The examples depicted in FIG. 7-10 and described herein are thus presented by way of example only, and system 520 of the present invention may be embodied in forms other than those described herein.

### III. Third Embodiment

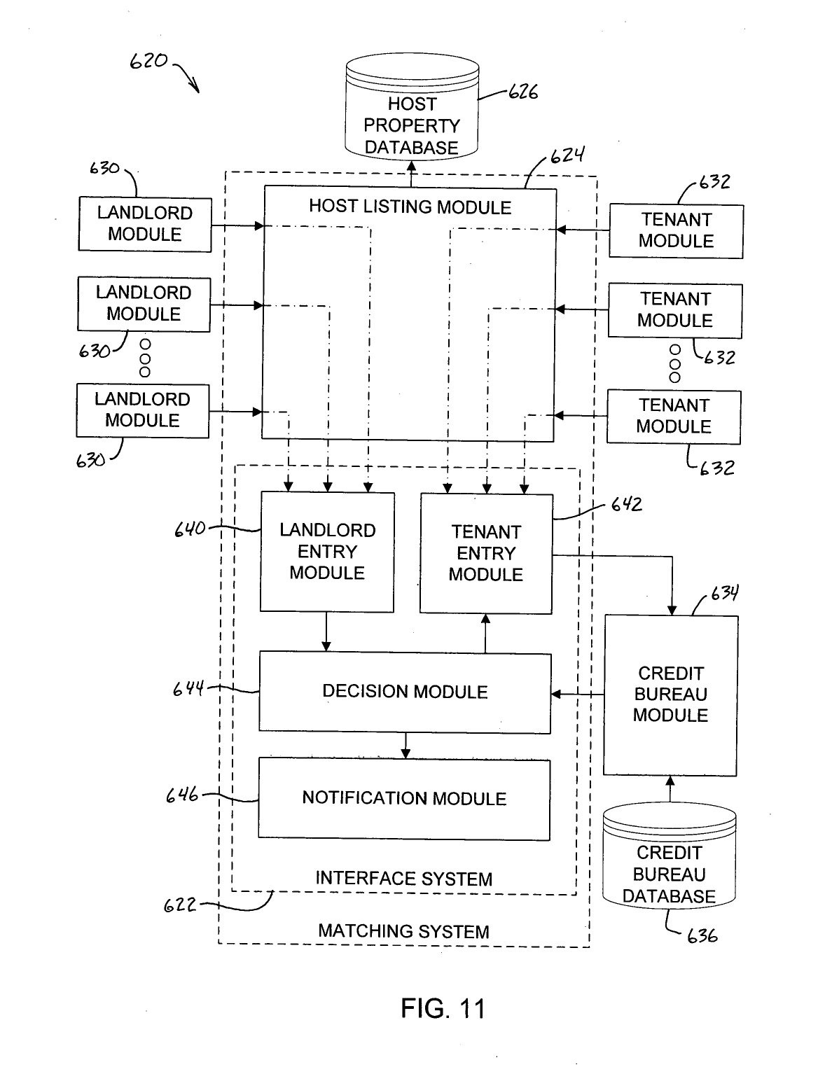

Referring now to FIG. 11 of the drawing, depicted at 620 therein is a third example matching system constructed in accordance with, and embodying, the principles of the present invention. The third example matching system 620 illustrates the principles of the present invention in the context of a host listing module such as that operated by a newspaper, apartment complex, or other entity that lists properties online.

The third example matching system 620 comprises an interface system 622 and a host listing module 624. The host listing module 624 coordinates communication among the interface system 622, one or more landlord entry modules 630, and one or more tenant entry modules 632. The interface system coordinates communications with a credit bureau module 634. The credit bureau module 634 facilitates access by the interface system 622 to a credit bureau database 636. The example interface system 622 comprises a landlord entry module 640, a tenant entry module 642, a decision module 644, and a notification module 646.

The example matching system 620 operates basically as follows. The host listing module 624 presents a user interface, typically in the form of a web page or pages, that allows landlords operating the landlord entry modules 630 to enter properties into the host property database 626 and tenants using the tenant entry modules 642 to enter search criteria to search for properties in the host property database 626. The host listing module 624 is or may be conventional in most respects and will be described herein only as necessary for a complete understanding of the present invention.

More specifically, the landlord entry modules 630 allow landlords to enter into the host listing module 624 property data associated with one or more properties. The example host listing module 624 differs from conventional host listing modules in that the landlord is further presented with the option requiring prospective tenants to allow the interface system 622 to perform a credit check on the prospective tenants.

If the landlord elects to use the credit check services offered by the interface system 622, the host listing module 624 connects the landlord entry module 630 to the landlord entry module 640. The landlord entry module prompts the landlord to enter a property grade representing the minimum acceptable credit level acceptable for that property. The property grade is stored in a transaction record by the decision module 644.

The tenant entry module 642 allows the prospective tenant to enter search criteria defining desired properties in the host property database 626. Based on the search criteria, the host listing module 624 generates a list of matching properties meeting the tenants search criteria. For any property in the list of matching properties for which the landlord has elected to use the credit check services offered by the interface system 622, a user interface element such as an “APPLY NOW” button will be presented. If the prospective tenant selects the “APPLY NOW” button, the user is redirected to the tenant entry module and prompted to enter tenant information that is passed to the credit bureau module 634.

The credit bureau module 634 generates a tenant grade for the prospective tenant based on the tenant information received from the tenant entry module 642 and the contents of the credit bureau database 636. The credit bureau module 634 transmits the tenant grade to the decision module 644. The decision module 644 may be configured to store the tenant grade for a period of time.

The decision module 644 receives the tenant grade and compares the tenant grade with the minimum acceptable credit level associated with the particular property. The decision module 644 instructs the notification module 646 to generate an “accepted” message if the tenant grade is equal to or greater than the minimum acceptable credit level associated with the particular property and a “declined” message if the tenant grade is equal to or greater than the minimum acceptable credit level associated with the particular property. The “accepted” or “declined” messages are sent to the particular landlord and the prospective tenant.

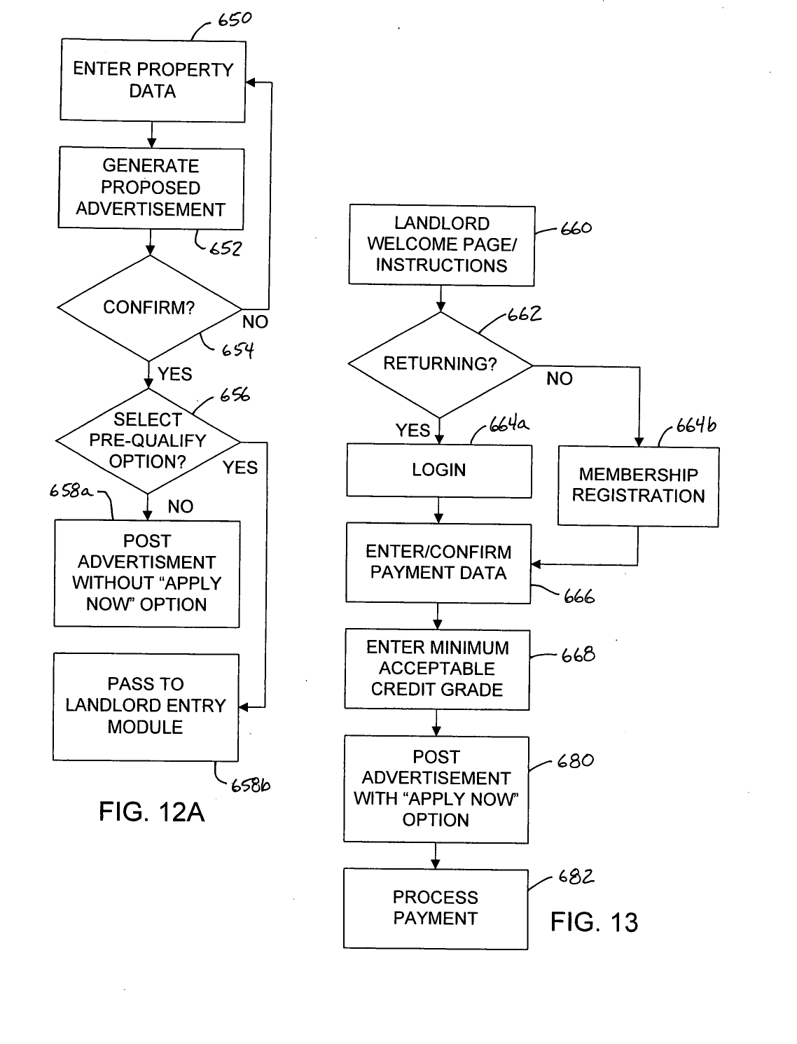

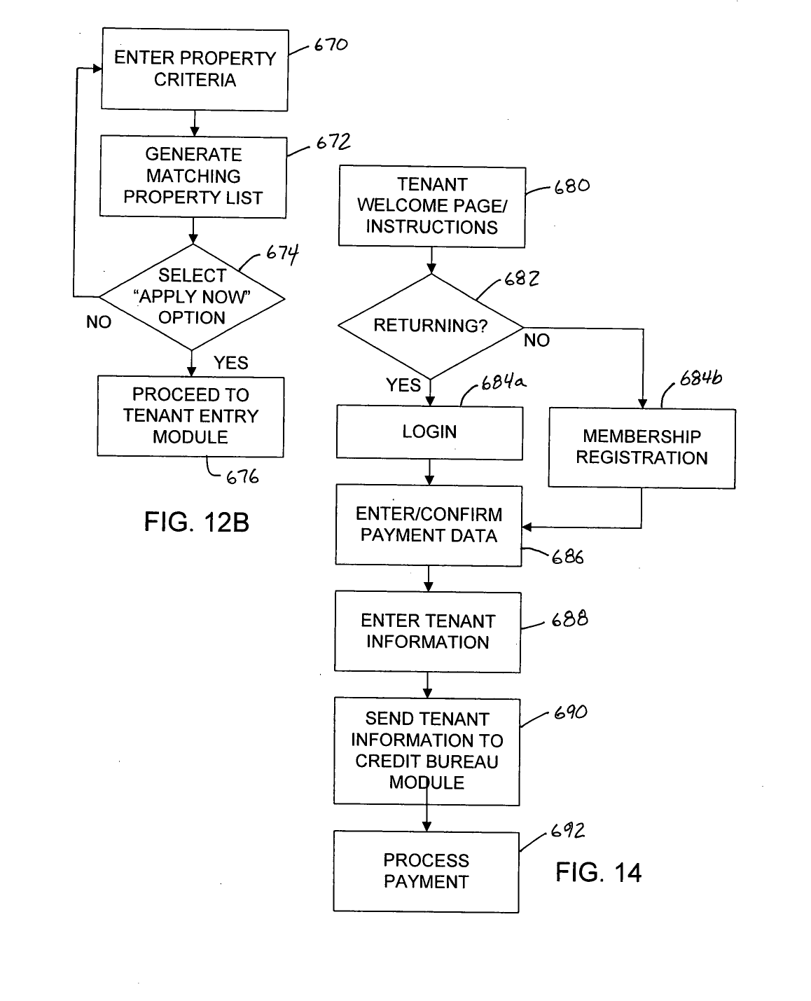

Referring now to FIG. 12A of the drawing, the interaction between the example host listing module 624 and the landlord entry module 630 will be described in further detail. The landlord is prompted at step 650 to enter property data. A proposed advertisement is generated at step 652, and the landlord is asked to confirm that the proposed advertisement is acceptable at step 654. If the proposed advertisement is not acceptable, the system returns to step 650 to allow the user to change the advertisement.

If the proposed advertisement is acceptable, the landlord is presented at step 656 with the choice of selecting a pre-qualify option. If the landlord declines to use the pre-qualify option, the advertisement is posted at step 658a without an “APPLY NOW” option. If the landlord elects to use the pre-qualify option, the landlord is passed to the landlord entry module at step 658b.

As shown in FIG. 13, the example landlord entry module 640 presents the landlord with a welcome/instruction screen 660 that introduces the prospective landlord to the example matching system 620. The landlord entry module 640 next determines at step 662 whether or not the prospective landlord is a returning member. If so, the process proceeds to a login step 664a. If not, the process requests the landlord to enter at least a minimum of amount of information at step 664b.

After either of these steps 664a and 664b, the process requests that the landlord enter or confirm payment information at step 666. The payment information typically takes the form of credit card information, but other payment methods can be used as well. At step 668, the landlord entry module 640 prompts the landlord to enter a description of the property and a minimum acceptable property grade. As described above, the minimum acceptable credit grade can take many forms, such as conventional number or letter grades (e.g., A, B, C, etc.), icon ratings (1 star, 2 star, 3 star, etc.), and binary ratings (good, better). As shown at step 680, the landlord entry module 640 confirms that the advertisement should be posted with the “APPLY NOW” option, and then payment is processed at step 682.

Referring now to FIG. 12B of the drawing, the interaction between the host listing module 624 and the tenant entry modules 632 will now be described. Initially, the prospective tenant enters property criteria at a step 670. The host listing module 624 then generates a list of matching properties at step 672.

If any of the properties in the list of matching properties contains requires a credit check, the prospective tenant is provided with the option to apply for a credit check at step 674. If the tenant elects not to apply for a credit check at step 674, the tenant may be returned to step 670 to change the property criteria. If the tenant elects to apply for a credit check at step 674, the tenant is directed at step 676 to the tenant entry module 642.

The operation of the example tenant entry module 642 will now be described in further detail with respect to FIG. 14. The prospective tenant is initially presented with a welcome/instruction screen 680 that introduces the prospective tenant to the example matching system 620. The tenant entry module 642 next determines at step 682 whether or not the prospective tenant is a returning member. If so, the process proceeds to a login step 684a. If not, the process requests the tenant to enter membership information at step 684b.

After either of these steps 684a and 684b, the process requests that the tenant enter or confirm payment information at step 686. The payment information typically takes the form of credit card information, but other payment methods can be used as well. At step 688, the tenant entry module prompts the prospective tenant to enter any information and authorization required to complete a credit check.

With the permission of the prospective tenant, the tenant entry module 642 next sends, at step 690, a tenant grade request to the credit bureau module 634. The tenant grade request contains enough of the tenant information to allow the credit bureau module 634 to generate the tenant grade. At step 692, the tenant entry module 642 processes payment (e.g., obtains payment from a credit card company).

The credit bureau module 634, decision module 644, and notification module 646 may operate in the same manner as the credit bureau module 534, decision module 544, and notification module 546 described above.

As described above, a typical web page defines an interface that allows the user to enter data in any order, so long as data input logic is maintained. Many of the steps described above with reference to FIGS. 11-14 thus may be performed in an order different from the order described herein. In addition, certain of the steps depicted and described with reference to FIGS. 11-14 may be omitted. The examples depicted in FIG. 11-14 and described herein are thus presented by way of example only, and system 620 of the present invention may be embodied in forms other than those described herein.

### IV. Fourth Embodiment

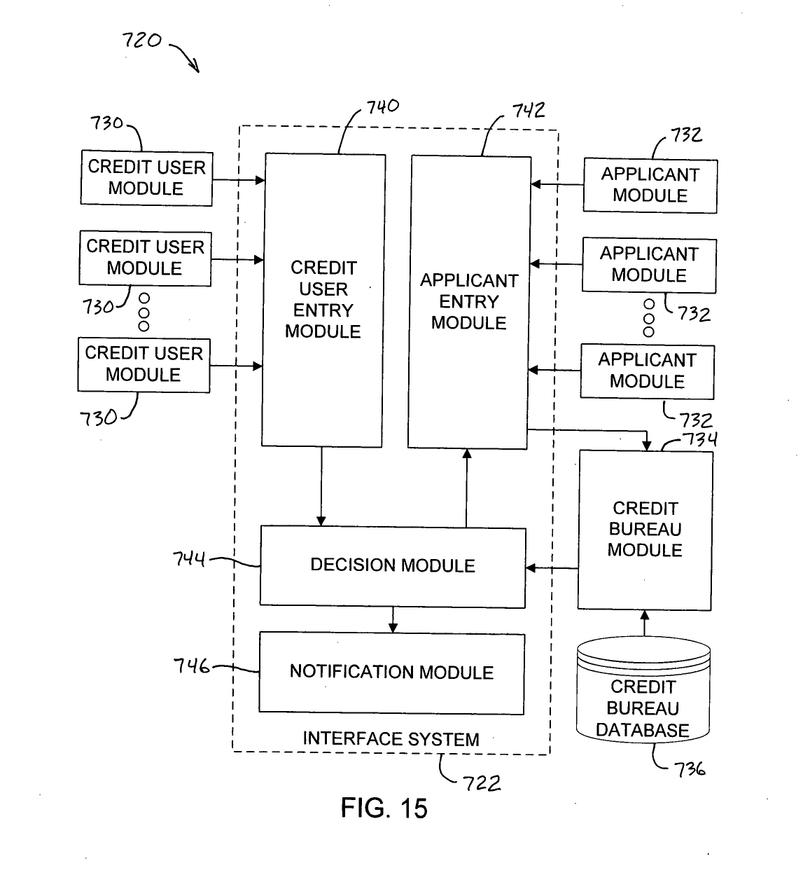

Referring now to FIG. 15 of the drawing, depicted at 720 therein is a fourth example matching system constructed in accordance with, and embodying, the principles of the present invention. The fourth example matching system 720 illustrates the principles of the present invention in the context of generic credit users who have a position of interest to applicants. The credit user may be an employer, volunteer organization, or any other entity offering a position to applicants where credit history may be of relevance to the position.

The fourth example matching system 720 comprises an interface system 722 that coordinates communication between one or more credit user modules 730, one or more applicant modules 732, and a credit bureau module 734. The credit bureau module 734 facilitates access by the interface system 722 to a credit bureau database 736. The example interface system 722 comprises a credit user module 740, a applicant module 742, a decision module 744, and a notification module 746.

The example matching system 720 operates basically as follows. The credit user module 740 allows a particular credit user to enter into the interface system 722 position data associated with the predetermined position and applicant contact data associated with a prospective applicant. The position data contains a minimum acceptable credit level chosen by the particular credit user for the predetermined position and is stored in a transaction record by the decision module 744. In the example matching system 720, the applicant contact data is transferred to the notification module 746, which sends an information request message, typically using email, to the prospective applicant.

The applicant module 742 allows the prospective applicant to enter applicant information in response to the information request message. The applicant module 742 passes the applicant information to the credit bureau module 734 and may be configured to store the applicant data for a period of time.

The credit bureau module 734 generates a applicant grade for the prospective applicant based on the applicant information received from the applicant module 742 and the contents of the credit bureau database 736. The credit bureau module 734 transmits the applicant grade to the decision module 744. The decision module 744 may be configured to store the applicant grade for a period of time.

The decision module 744 receives the applicant grade and compares the applicant grade with the minimum acceptable credit level associated with the particular position. The decision module 744 instructs the notification module 746 to generate an “accepted” message if the applicant grade is equal to or greater than the minimum acceptable credit level associated with the particular position and a “declined” message if the applicant grade is equal to or greater than the minimum acceptable credit level associated with the particular position. The “accepted” or “declined” messages are sent to the particular credit user and the prospective applicant.

The credit bureau module 734, credit user entry module 740, applicant entry module 742, decision module 744, and notification module 746 may operate in the same general manner as the credit bureau module 634, credit user entry module 640, applicant entry module 642, decision module 644, and notification module 646 described above.

### V. Additional Considerations

From the foregoing, it should be apparent that the present invention may be embodied in many different combinations and sub-combinations of the elements and steps described above.

For example, the interface systems described above may be configured to notify applicants (e.g., prospective tenants) of future positions (e.g., rental properties) for which they are pre-approved. Also, credit users (e.g., landlords) may be provided with the option to invite pre-approved applicants. If an applicant is declined for a particular position, the applicant may be notified of alternated positions for which the applicant is qualified. The interface system may also be configured to allow credit users to view lists of qualified applicants and select one or more qualified applicants for the purposes of soliciting the applicant for a particular position.

In any situation in which a qualified applicant has been pre-approved, the interface system may be configured to send an email asking the qualified applicant to apply for a position. In this case, the email may contain a link that connects the qualified applicant to the interface system.

The interface system may also be provided with a fraud detection system that assesses the probability that a particular application is fraudulent. Fraud detection may be implemented, for example, by means such as validating social security numbers and cross-referencing to death records.

The example systems described above assume that both the tenant and the landlord have access to a module that allows access to the landlord entry module and/or tenant entry module. This assumption may not be true in all situations, however.

In a situation where the landlord does not have online access to the matching system of the present invention, the landlord can fill out, by hand, a form with the required information. The form can then be faxed to a service operating the matching system for manual entry of the data. An email message may then be sent to the tenant prompting the tenant to use the system to enter the tenant information for the purpose of allowing the tenant grade to be calculated.

In another situation, the tenant may not have access to email or a tenant entry module. In this case, the landlord can enter data into the matching system and notify the potential tenant by means other than email, such as by telephone or in person, that the tenant information is required. The tenant then borrows a web browser, such as a computer at the landlord's premise or possibly a publicly available computer, to log in to the matching system and enter the tenant information for the purpose of allowing the tenant grade to be calculated.

The scope of the present invention should thus be determined by any claims appended hereto and not the foregoing detailed description.

What is claimed is:

1. An interface system for matching a position with an applicant based on credit information, comprising:
a credit user entry module that allows a credit user to define the position and enter a position grade associated with the position;
an applicant entry module that allows the applicant to enter applicant information;
a credit bureau module that generates an applicant grade based on the applicant information and credit information stored in a credit bureau database;
a decision module for comparing the position grade with the applicant grade to determine whether the applicant is qualified for the position; and
a notification module for notifying the credit user and the applicant whether the applicant is qualified for the position.

2. An interface system as recited in claim 1, further comprising a listing database for storing a listing of positions.

3. An interface system as recited in claim 2, in which the credit user entry module allows the credit user to enter position data for storage in the listing database.

4. An interface system as recited in claim 1, in which the applicant entry module allows the applicant to search the listing database for positions of interest.

5. An interface system for matching a prospective tenant with a property offered by a landlord with based on credit information, comprising:
a landlord entry module that allows the landlord to identify the property and enter a property grade associated with the property;
a tenant entry module that allows the prospective tenant to enter prospective tenant information;
a credit bureau module that generates a prospective tenant grade based on the prospective tenant information and credit information stored in a credit bureau database;
a decision module for comparing the property grade with the prospective tenant grade to determine whether the prospective tenant is qualified for the property; and
a notification module for notifying the landlord and the prospective tenant whether the prospective tenant is qualified for the property.

6. An interface system as recited in claim 5, further comprising a listing database for storing a listing of properties.

7. An interface system as recited in claim 6, in which the landlord entry module allows the landlord to enter property data for storage in the listing database.

8. An interface system as recited in claim 7, in which the tenant entry module allows the prospective tenant to search the listing database for properties of interest.

9. An interface system for matching prospective tenants with properties offered by landlords based on credit information, comprising:
a landlord entry module that allows the landlords to enter property data and a property grade for the properties;
a tenant entry module that allows the prospective tenants to apply for at least one property by entering prospective tenant information;
a credit bureau module that generates prospective tenant grades based on the prospective tenant information and credit information stored in a credit bureau database;
a decision module for comparing the property grades with the prospective tenant grades to determine whether any of the prospective tenants are qualified for any of the properties;
and
a notification module for notifying landlords and prospective tenants whether any of the prospective tenants are qualified for any of the properties.

10. An interface system as recited in claim 9, in which the tenant entry module allows the prospective tenants to search the listing database for properties of interest.

11. An interface system as recited in claim 9, in which the decision module stores the prospective tenant grades notifies the prospective tenants of any properties for which the prospective tenants are qualified that are listed after the prospective tenant enters the prospective tenant information.

12. An interface system as recited in claim 9, in which the decision module notifies landlords of all prospective tenants who are qualified for each of the properties listed by the landlords.

13. An interface system as recited in claim 9, in which:
the landlord entry module allows the landlords to select one property grade from a plurality of ranked property grades; and
a decision module determines that prospective tenants are qualified for properties if ranks of prospective tenant grades are equal to or greater than ranks of property grades.

14. An interface system as recited in claim 9, in which the landlord entry module offers to landlords additional background check services.

15. An interface system as recited in claim 9, further comprising a property database, where the landlord entry module stores in the property database a listing of properties and associated property data and property grades.

16. An interface system as recited in claim 9, further comprising a host listing service, where the host listing service maintains a property database containing a listing of properties and associated property data and property grades.

17. An interface system as recited in claim 16, in which the host listing service offers landlords the opportunity to require prospective tenants submit tenant information when applying for properties.

18. An interface system as recited in claim 16, in which the host listing service offers prospective tenants the opportunity to submit tenant information when applying for properties.
